(19) United States
(12) Patent Application Publication
(10) Pub. No.: US 2008/0222842 A1
(43) Pub. Date: Sep. 18, 2008

(54) GATE STABILIZER

(76) Inventor: Eric Brett Faber, Lexington, KY (US)

Correspondence Address: WYATT, TARRANT & COMBS, LLP, 1715 AARON BRENNER DRIVE, SUITE 800, MEMPHIS, TN, 38120-4367, US

(21) Appl. No.: 11/680,251

(22) Filed: Feb. 28, 2007

(51) Int. Cl. E05D 13/00; E05D 7/06

(52) U.S. Cl. 16/86.1; 16/240

(57) ABSTRACT

The present invention relates to a gate stabilizer for reducing sag-inducing stress on a gate comprising a support member and a stabilizer assembly, said stabilizer assembly including a rotating member having a first end portion adapted to engage said support member and a fixed member. The present invention further relates to a fence system incorporating said gate stabilizer.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention generally relates to fence gates. More specifically, the invention is a gate stabilizer intended to eliminate gate sag, reduce the stress on gate hinges, and prevent a gate from being forced open.

2. General Background of the Invention

Gate systems, and particularly livestock gates that are usually heavier and larger than normal fence gates, in which the gate hangs on hinges attached to a gate post but is not otherwise supported are plagued by a unique set of problems. One problem routinely experienced by users of these gates is the tendency of gates to sag in at least two non-exclusive manners. First, the sag may result from the failure of the gate structure itself. Second, the otherwise unsupported weight of the gate can cause the gate post to bend or tilt.

The first failure is caused by the fact that the gate is only supported at one end by the hinges that are attached to the gate post. This results in the weight of the gate applying forces to the internal structure of the gate that can result in failure over time.

The second failure is caused by the force couple the weight of the gate applies to the gate post through the hinges. Since the opposing end of the gate is unsupported, the weight of the gate acts to pull the upper hinge, and therefore the upper portion of the gate post, toward the gate. Simultaneously, the weight of the gate acts to push the lower hinge, and therefore the lower portion of the gate post, away from the gate. Over time, this can cause the fence post to bend or to tilt relative to its original positioning thereby causing the gate to sag.

Prior solutions to this problem have tended to create additional problems. For example, the free end of the gate can be supported by a wheel, but this makes the gate difficult to operate as it does not swing freely, especially when the gate is installed over uneven ground or gravel. Other solutions have focused on devices that increase stress on the hinges by employing tactics such as tensioning a gate to a gate post. Other approaches to resolving this problem result in a weakening of the gate structure as a whole by reducing the strength or weight of the gate itself. Alternatively, other methods rely on hinges of increased strength to attempt to counterbalance the stress of the gate.

In summary, no real effort has been made to remedy the cause of gate sag by reducing the stress applied to the hinges and the structure of the gate. Instead, known devices and methods either attempt to compensate for the problem of gate sag once it has occurred or create added stress on the gate and hinges that eventually results in gate sag.

Another problem faced by typical gate structures is that the unsupported gate latches only at the middle to upper portion of the gate. This makes the gate susceptible to being forced open at the lower portion by an animal or child being contained or excluded in part by the gate. This typical structure also results in a gate system that is susceptible to vibration and movement that may cause injury to livestock.

The object of this invention then is address the above identified problems by providing an apparatus that can is inexpensive and easy to apply to both gate systems that are already in service and new gate systems regardless of what side the gate is hinged on. In addition to reducing the stress on the gate and the gate post, the present invention is livestock proof, meaning that it cannot be opened by the nose, shoulder, or hoof of animals such as cows, horses, pigs, sheep, and goats.

### SUMMARY OF THE INVENTION

The present invention relates to an apparatus for reducing sag-inducing stress on a gate comprising a support member and a stabilizer assembly, said stabilizer assembly including a rotating member having a first end portion adapted to engage said support member and a fixed member. The present invention further relates to methods for using said apparatus.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an exploded, perspective view of an embodiment of the present invention.

FIG. 2 is a perspective view of an embodiment of the present invention as mounted on a gate and latch post.

FIG. 3 is a top elevation view of an embodiment of the present invention.

FIG. 4 is a pictorial view of an embodiment of the present invention installed in a gate system.

FIGS. 5A, 5B, and 5C are pictorial views of an embodiment of the present invention in use.

### DETAILED DESCRIPTION OF THE INVENTION

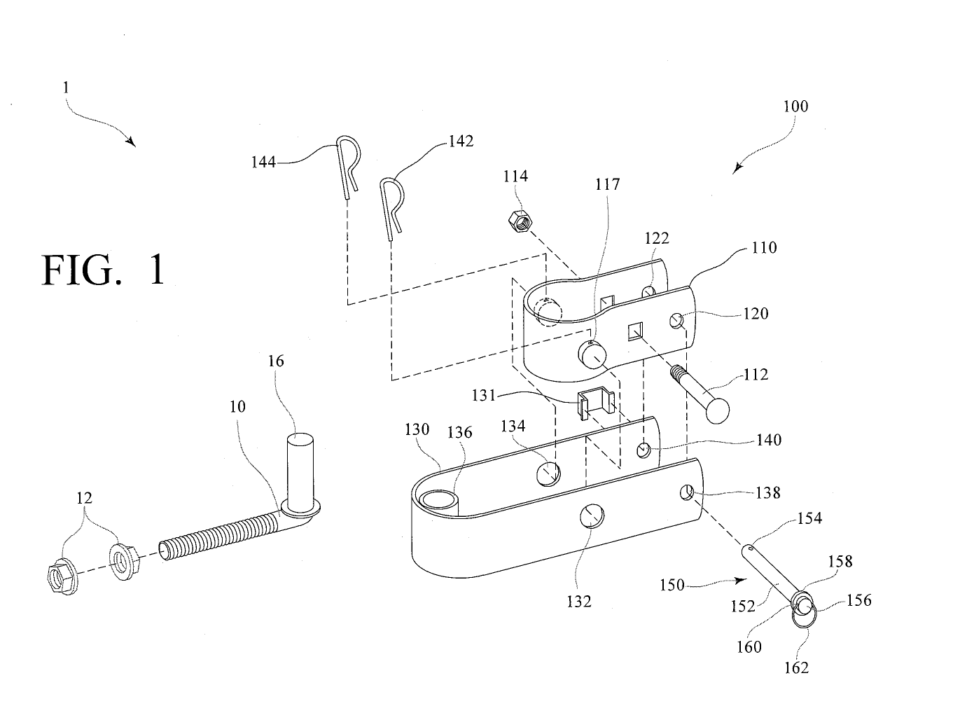

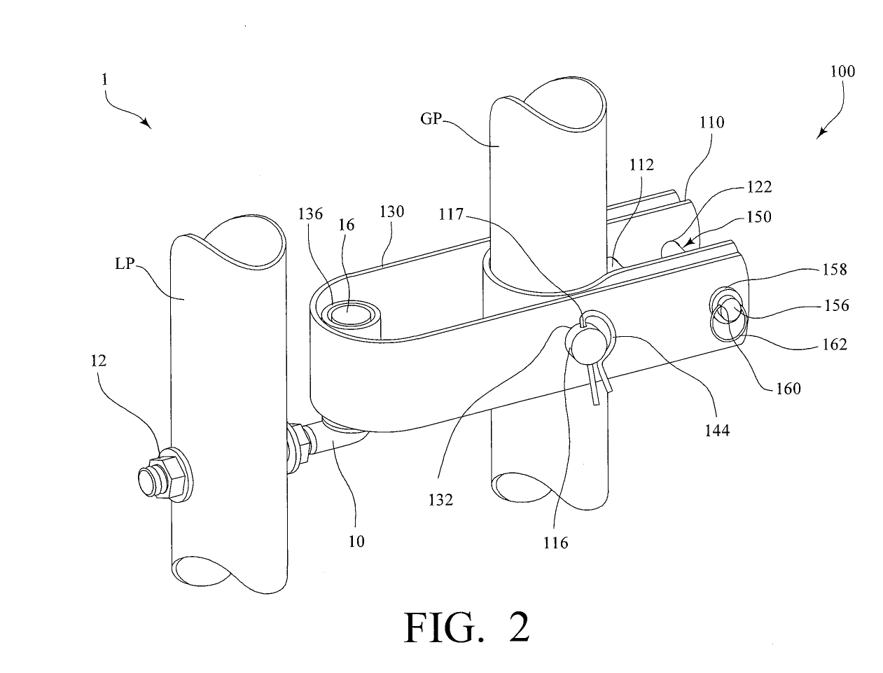

FIG. 1 shows an embodiment of the present invention —gate stabilizer 1 formed from galvanized steel. In the embodiment shown in FIG. 1, gate stabilizer 1 includes L-shaped support member 10 and stabilizer assembly 100. In the illustrated embodiment, support member 10 is sized to pass through latch post LP as best seen in FIG. 2. Support member 10 is affixed to latch post LP using nuts 12. Support member 10 includes upstanding cylindrical portion 16.

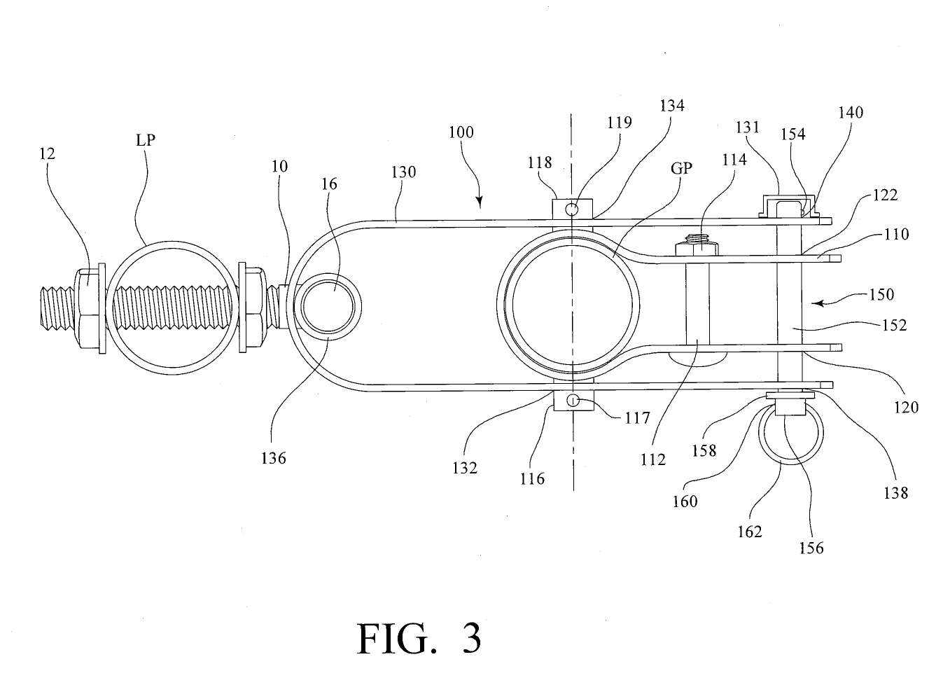

Still referring to FIG. 1, stabilizer assembly 100 includes fixed member 110. In the embodiment shown in FIG. 1, fixed member 110 is a generally U-shaped member adapted to wrap around the gate post GP as best seen in FIG. 3. In the illustrated embodiment, fixed member 110 is attached to gate post GP by compressing fixed member 110 around gate post GP using bolt 112 and nut 114 (best seen in FIG. 3). Of course other methods of attaching fixed member 110 may be used including, but not limited to, bolting it directly to gate post GP or welding it directly to gate post GP. Fixed member 110 further includes cylindrical projections 116 and 118 (best seen in FIG. 3) extending from its sides along the centerline of gatepost GP. And the end portion of fixed member 110 is adapted to receive coupling pin 150 through the inclusion of a pair of coupling apertures 120 and 122 that coupling pin 150 can pass through.

Still referring to FIG. 1, stabilizer assembly 100 further includes rotating member 130. In the illustrated embodiment, rotating member 130 is a generally U-shaped member that includes a pair of rotational apertures 132 and 134 located opposite each other at the midpoint of its length. Rotational apertures 132 and 134 are sized to receive cylindrical projections 116 and 118, allowing rotating member 130 to rotate about cylindrical projections 116 and 118. The end portion of rotating member 130 including the closed portion of the “U” is adapted to engage support member 10. In the illustrated embodiment, this adaptation comprises tubular member 136, which is permanently affixed to the inner surface of rotating member 130 and sized to receive cylindrical member 16 of support member 10. The opposing end portion of rotating member 110 is adapted to receive coupling pin 150 through the inclusion of a pair of coupling apertures 138 and 140.

Still referring to FIG. 1, cylindrical projections 116 and 118 include holes 117 and 119 (best seen in FIG. 3) located in the end portion of each projection opposite fixed member 110. In the illustrated embodiment, spring-type cotter pins 142 and 144 pass through holes 117 and 119 respectively to hold rotating member 130 in place.

Still referring to FIGS. 1 and 2, coupling pin 150 includes a cylindrical shaft 152 sized to pass through coupling apertures 120, 122, 138, and 140. Spring-loaded ball-bearing 154 is located toward one end of cylindrical shaft 152 to prevent coupling pin 150 from being inadvertently removed. Cap 156 is mounted at the opposing end of cylindrical shaft 152. Cap 156 includes flange 158 that is larger in diameter than coupling aperture 138. Cap 152 further includes opening 160 through which wire ring 162 passes. Shroud 131 is attached to coupling member 130 such that it shields the end of coupling pin 150 toward which spring-loaded ball-bearing 154 is located to prevent livestock from being able to inadvertently dislodging coupling pin 150. While shroud 131 is shown as being rectangular and open at the top and bottom, shroud 131 can take on any shape that prevents an animal from contacting the end of coupling pin 150. For example, instead of being open at the top, the top of shroud 131 could be connected to rotating member 130 at an angle.

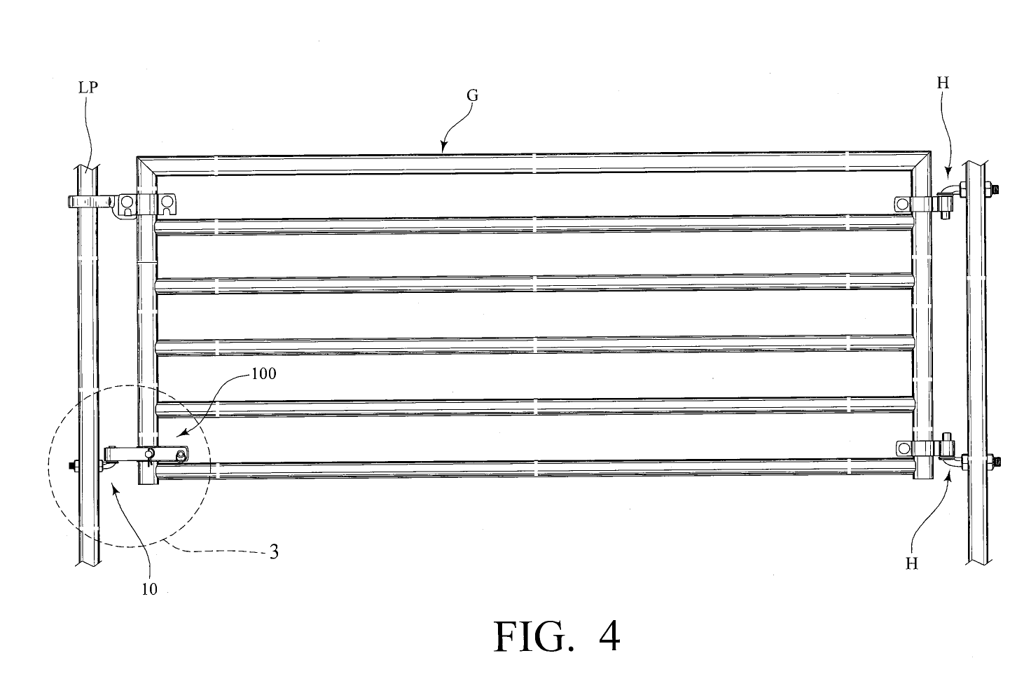

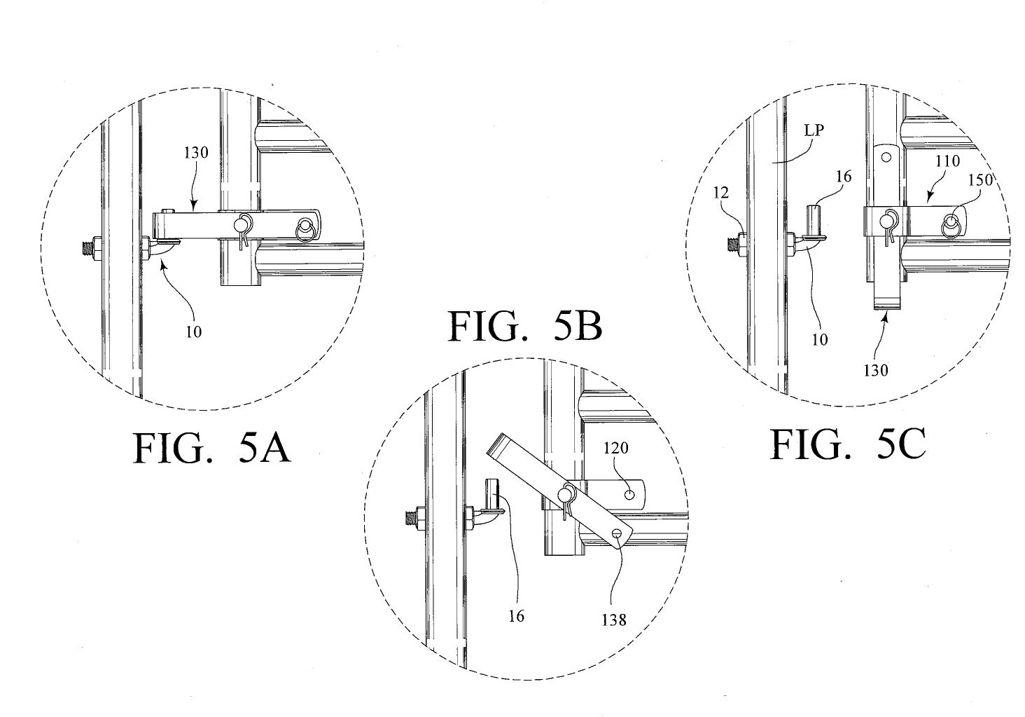

Referring now to FIG. 4, stabilizer assembly 100 is mounted on the end of gate G opposite hinges H. Support member 10 is affixed to latch post LP opposite stabilizer assembly 100. Gate stabilizer 1 operates to reduce sag inducing stress in gate G and hinges H when rotating member 130 is engaged with support member 10 as shown in FIG. 5A by supporting a portion of the weight of gate G. This results in a lessening of the forces on hinges H and the forces within the members of gate G that tend to cause gate sag.

In the illustrated embodiment, stabilizer assembly 100 is located toward the bottom of gate G on gate post GP such that rotating member 130 can be allowed to hang parallel to gate post GP in a disengaged position when it is not engaged with support member 10 as shown in FIG. 5C. This allows rotating member 130 to be out of the way when gate G is opened and closed. This location has the added benefit of increasing the ability of the gate to retain animals by preventing the lower portion of the gate from being pushed outward when rotating member 130 is engaged with support member 10.

In an alternate embodiment, gate post GP could include a through hole that would align with holes 138 and 140 when rotating member is in the disengaged position. This would allow coupling pin 150 to lock rotating member 130 in its disengaged position to prevent it from inadvertently rotating when gate G is opened or closed. This would also provide a place to store coupling pin 150 when gate stabilizer 1 is not engaged. Alternatively, as shown in FIG. 5C, coupling pin 150 can be inserted through coupling apertures 120 and 122 in fixed member 110 when gate stabilizer 1 is not engaged.

In an alternative application, gate stabilizer 1 could be mounted toward the top of gate G to replace conventional latch L. If used in this manner, gate stabilizer 1 would provide the gate latching function in addition to reducing sag-inducing stress by carrying a portion of the weight of gate G unlike conventional latch L.

Gate stabilizer 1 is used to reduce sag-inducing stress in Gate G by affixing stabilizer assembly 100 to gate post GP on the end of gate G opposite hinges H. Support member 10 is then affixed to latch post LP opposite stabilizer assembly 100. Gate stabilizer 1 is then engaged by rotating the engagement end of rotating member 130 up toward gate post GP. Gate G is then moved to its closed position. The engagement end of rotating member 130 is then rotated down to engage support member 10. Coupling apertures 138 and 140 in the opposing end of rotating member 130 are then aligned with coupling apertures 120 and 122 in fixed member 110 and coupling pin 150 is passed though coupling apertures 138, 120, 122, and 140 to firmly fix rotating member 130 relative to fixed member 110. Gate stabilizer 1 is disengaged by reversing these steps.

While the above describes the illustrated embodiment, those skilled in the art may appreciate that certain modifications may be made to the apparatus and methodology herein disclosed, without departing from the scope and spirit of the invention. For example, one or both of fixed member 110 and rotating member 130 could be a flat member instead of a U-shaped member. In such a configuration, shroud 131 could be mounted to either rotating member 130 or fixed member 110 as required to shield the end of coupling pin 150. Also, coupling pin 150 could be a padlock instead of a cylindrical device. Thus, it should be understood that the invention may be adapted to numerous rearrangements, modifications, and alterations and that all such are intended to be within the scope of the appended claims.

I claim:

1. A gate stabilizer for reducing sag-inducing stress comprising:
a support member; and
a stabilizer assembly, said stabilizer assembly including a rotating member having a first end portion adapted to engage said support member.

2. The gate stabilizer of claim 1 wherein said stabilizer assembly further comprises means for affixing said rotating member in engagement with said support member.

3. The gate stabilizer of claim 2 wherein said means for affixing comprises:
a fixed member and a means for coupling said rotating member to said fixed member.

4. The gate stabilizer of claim 3 wherein said means for coupling further comprises:
at least one coupling aperture defined in said rotating member;
at least one coupling aperture defined in said fixed member, wherein the at least one coupling aperture defined in said rotating member aligns with the at least one coupling aperture defined in said fixed member when said rotating member is engaged with said support member; and
a coupling pin having a shaft sized to pass through the at least one coupling aperture defined in said rotating member and the at least one coupling aperture defined in said fixed member.

5. The gate stabilizer of claim 4 wherein said coupling pin further comprises:
a cap located at a first end of said shaft, said cap having a flange, said flange having a diameter greater than the at least one coupling aperture defined in said fixed member and the at least one coupling aperture defined in said rotating member; and
a spring-loaded ball-bearing located toward a second end of said shaft.

6. The gate stabilizer of claim 1 further comprising:
a fixed member and
a coupling pin wherein
said rotating member defines at least one coupling aperture;
said fixed member defines at least one coupling aperture, the at least one coupling aperture defined by said rotating member being aligned with the at least one coupling aperture in said fixed member when said rotating member is engaged with said support member; and
said coupling pin includes a shaft, said shaft being sized to pass through said at least one coupling aperture defined in said rotating member and said at least one coupling aperture defined in said fixed member.

7. A gate stabilizing device comprising:
a support member;
a U-shaped fixed member having a closed end, an open end, and a pair of sides; and
a U-shaped rotating member having a closed end, an open end, and a pair of sides rotationally connected to said U-shaped fixed member wherein the closed end of said U-shaped rotating member is adapted to engage said support member.

8. The gate stabilizing device of claim 7 wherein:
each of the sides of the U-shaped rotating member defines a rotational aperture located near the midpoint of the length of U-shaped rotating member;
said U-shaped fixed member has a projection extending from each side, said projections being located on said sides near the closed end of said U-shaped fixed member and extending through said rotational apertures in said U-shaped rotating member.

9. The gate stabilizing device of claim 8 further comprising means for affixing said U-shaped rotating member in engagement with said support member.

10. The gate stabilizing device of claim 8 wherein
each of the sides of said U-shaped rotating member defines a coupling aperture, each said coupling aperture being located toward the open end of said U-shaped rotating member;
each of the sides of said U-shaped fixed member defines a coupling aperture, each said coupling aperture being located toward the open end of said U-shaped fixed member, wherein the coupling apertures in said U-shaped rotating member align with the coupling apertures in said U-shaped fixed member when said U-shaped rotating member is engaged with said support member; and
a coupling pin, said coupling pin having a shaft sized to pass through said coupling apertures and a length sufficient to simultaneously extend though each of said coupling apertures.

11. A fencing system comprising:
a gate, said gate having
a hinge end portion, said hinge end portion including at least one hinge and
a latching end portion, said latching end portion including a vertical member;
a hinge post to which said at least one hinge is connected;
a latching post;
a gate stabilizer, said gate stabilizer including
a support member connected to said latching post;
a U-shaped fixed member having a closed end, an open end, and a pair of sides connected to the vertical member of the latching portion of said gate;
a U-shaped rotating member having a closed end, an open end, and a pair of sides rotationally connected to the U-shaped fixed member wherein the closed end of said U-shaped rotating member is adapted to engage said support member.

12. The fencing system of claim 11 wherein
each of the sides of said U-shaped rotating member defines a coupling aperture, each said coupling aperture being located toward the open end of said U-shaped rotating member;
each of the sides of said U-shaped fixed member defines a coupling aperture, each said coupling aperture being located toward the open end of said U-shaped fixed member, wherein the coupling apertures in said U-shaped rotating member align with the coupling apertures in said U-shaped fixed member when said U-shaped rotating member is engaged with said support member; and
a coupling pin, said coupling pin having a shaft sized to pass through said coupling apertures and a length sufficient to simultaneously extend though each of said coupling apertures.

13. The fencing system of claim 11 wherein
said support member has an engagement end portion, said engagement end portion including an upstanding cylindrical member and
said U-shaped rotating member includes a tubular engagement portion enclosed within its closed end, the tubular engagement portion having a diameter sufficient to encompass the upstanding cylindrical member of said support member.
